(19) United States
(12) Patent Application Publication
(10) Pub. No.: US 2011/0181559 A1
(43) Pub. Date: Jul. 28, 2011

(54) DRIVER CIRCUIT

(75) Inventors: Yoshiyuki TANAKA, Kanagawa (JP); Eri YOSHIDA, Kanagawa (JP)

(73) Assignee: RENESAS ELECTRONICS CORPORATION, Kanagawa (JP)

(21) Appl. No.: 13/004,285

(22) Filed: Jan. 11, 2011

(30) Foreign Application Priority Data
Jan. 25, 2010 (JP) 2010-013374

(51) Int. Cl. G06F 3/038

(52) U.S. Cl. 345/204

(57) ABSTRACT

A source driver includes a dividing circuit, a start signal capturing unit, a pulse width determining unit and a control circuit. The dividing circuit produces a divided clock by dividing a basic clock signal. The start signal capturing unit captures the start signal at timing of the edge of the divided clock. The pulse width determining unit determines a pulse width of the start signal that is captured. The control circuit changes the timing to start capturing the data according to the pulse width of the start signal. With this structure, the latter source driver is able to adjust capturing timing to effective data timing input thereto, even though final data does not end at the falling edge of the divided clock signal.

### INCORPORATION BY REFERENCE

This application is based upon and claims the benefit of priority from Japanese patent application No. 2010-013374, filed on Jan. 25, 2010, the disclosure of which is incorporated herein in its entirety by reference.

### BACKGROUND

1. Field of the Invention

This present invention relates to a driver circuit of a liquid crystal display device. In particular, this present invention relates to a driver circuit in which a start signal is forwarded sequentially between a plurality of source drivers which are connected in series.

2. Description of Related Art

Due to an increase in size and high definition in liquid crystal display devices, there is a large increase in a rate of a clock signal used in source drivers which are coupled in series. This trend leads to a large increase in a rate of a basic clock signal to be used for transferring a start signal between a plurality of source drivers connected in series. Accordingly, time margin for setup and hold becomes short.

In patent document 1 (Japanese Unexamined Patent Application Publication No. H08-329696), there disclosed a method for securing a time margin for setup and hold, in which a latter circuit uses a divided clock signal to obtain the start signal. For instance, a divided clock signal having a cycle twice as long as that of a basic clock signal is produced from the basic clock signal by dividing operation. A flip-flop obtains the start signal at the timing of the rising edge of the divided clock signal, whereby a time margin for setup or the like can be secured

Recently, to meet various sizes of panels, a source driver has been required that allows various source drivers having different numbers of effective output channels to be connected in series and that is able to change the number of effective output channels. This is because such a configuration allows manufactures of liquid crystal display devices to design more flexibly the number of effective output channels in the entire display device. Furthermore, manufactures of source drivers can meet various needs of customers with one product.

When the number of the effective output channels differs, the number of the RGB data input to the source driver differs. However, the patent document 1 does not disclose a relationship between the final data of the RGB data and the divided clock signal. In the case where the final data does not end at the falling edge of the divided clock signal, because the timing of a data start pulse which indicates the latch timing for the source driver connected to the latter side does not match the timing of the first effective data, the relationship between the effective data and output may collapse.

### SUMMARY

It has now been discovered that there is problem that, in the patent document 1, starting timing and latch timing of the effective data input to the source driver connected to the latter side are out of synchronization, in the case where the final data does not end in the unit of the divided clock signal.

According to an aspect of the present invention, there is provided a driver circuit including a source driver adequate to cascade connection which forwards a start signal using a shift register. A former source driver obtains data according to a timing of a basic clock and outputs a start signal to a latter source driver in a period from the time the start signal sequentially forwarded between a plurality of source drivers connected in series is obtained by the former source driver to the time the start signal is obtained by the latter source driver. The source driver includes a dividing circuit, a start signal capturing unit, a pulse width determining unit and a control circuit. The dividing circuit produces a divided clock by dividing the basic clock signal. The start signal capturing unit captures the start signal at timing of the edge of the divided clock. The pulse width determining unit determines the pulse width of the start signal that is captured. The control circuit changes the timing to start capturing the data according to the pulse width of the start signal.

With this structure, even in the case where effective pixel data of the source driver does not end in the unit of the divided clock signal, the source driver is able to capture the data to meet the starting timing of the effective data by determining the data end status of the former source driver based on the pulse width of start signal that is received. According to the present invention, the latter source driver is able to adjust capturing timing to effective data timing input thereto, even though final data does not end at the falling edge of the divided clock signal.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a diagram showing a signal input to a source driver from a controller;

FIG. 2A is a diagram showing a configuration of an interface circuit as a comparative example of the source driver of an exemplary embodiment;

FIG. 2B is a diagram showing a configuration of a start signal capturing unit of the interface circuit shown in FIG. 2A.

FIG. 2C is a diagram showing a configuration of a start signal output unit of the interface circuit shown in FIG. 2A

FIG. 3 is a timing chart to explain an operation of the interface circuit shown in FIG. 2A;

FIG. 4A is a timing chart to explain an operation of a comparative example in the case where a divided clock signal is used;

FIG. 4B is a diagram showing a configuration of the start signal capturing unit of the interface circuit when the operation shown in FIG. 4A is executed;

FIG. 5A is a timing chart to explain an operation of a comparative example when a divided clock signal is used;

FIG. 5B is a timing chart to explain an operation of the comparative example when a divided clock signal is used;

FIG. 6 is a diagram showing a configuration of the interface circuit of the source driver in the exemplary embodiment;

FIG. 7 is a diagram showing a configuration of the start signal capturing unit of the source driver in the exemplary embodiment;

FIG. 8A is a timing chart to explain an operation for capturing the start signal by the source driver in the exemplary embodiment;

FIG. 8B is a timing chart to explain an operation for capturing the start signal by the source driver in the exemplary embodiment;

FIG. 9 is a diagram showing a configuration of the start signal output unit of the source driver in the exemplary embodiment;

FIG. 10 is a diagram to show states of each signal in the start signal output unit in the exemplary embodiment;

FIG. 11 is a diagram to explain an operation for outputting the start signal by the source driver in the exemplary embodiment; and

FIG. 12 is a diagram illustrating an example of a control processing when plural source drivers are connected.

### DETAILED DESCRIPTION OF THE EXEMPLARY EMBODIMENTS

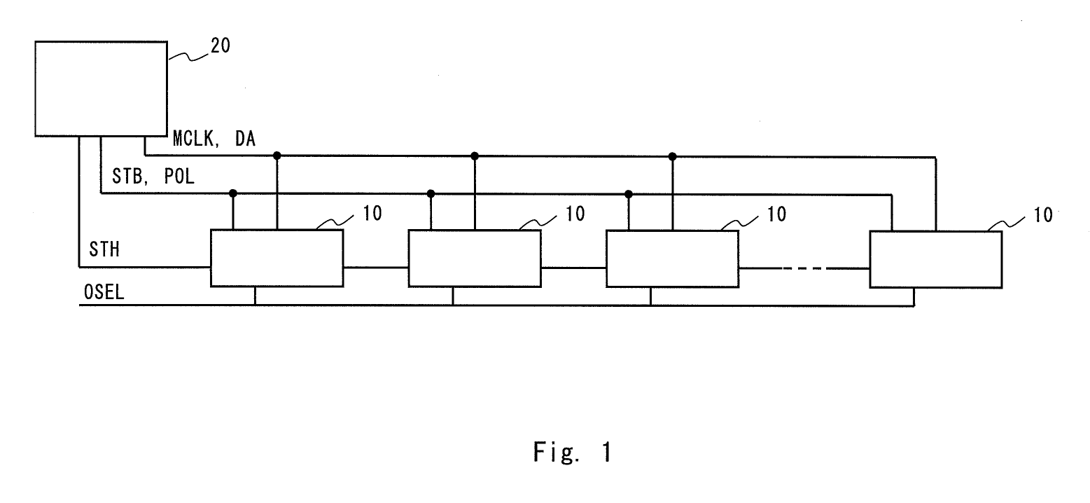

Hereinafter, embodiments of the present invention will be shown and described with reference to reference numerals and symbols assigned to components in the figures. First, prior to description of the exemplary embodiments of the present invention, described is the background for inventors to come up with this present invention. FIG. 1 is a diagram to explain a signal input to a source driver 10 from a controller 20. Here is given a description for a driver circuit having plural source drivers 10 connected in series.

As shown in FIG. 1, a start signal STH from the controller 20 is input to the source driver 10 arranged at the first stage. The start signal STH is forwarded sequentially between plural source drivers 10. A clock signal MCLK and a data signal DA (hereinafter, the both may be called integrally “high rate serial signal”) are input to each of the source drivers 10 from the controller 20 via a high rate I/F.

Furthermore, a strobe signal STB and a polarity signal POL are input to each of source drivers 10 from the controller 20 via CMOS I/F. A gray controlling voltage of one line is output from each of source drivers 10 to a liquid crystal display panel based on the strobe signal STB. The polarity signal POL is a signal to invert the polarity of the gray controlling voltage output to the liquid crystal display panel. The polarity signal POL is produced according to types to drive the liquid crystal display panel (that is, types of AC drive such as line inversion, column inversion or dots inversion).

Furthermore, a setting signal OSEL is input to each of source drivers 10 via a setting terminal. The setting signal OSEL is a signal to set the number of outputs for each of source drivers 10. For example, according to setting signal OSEL, the number of the outputs of the source driver 10 can be changed from 960 ch to 846 ch. In addition, different values of the setting signals OSEL maybe input to each of the source drivers 10, so that the source drivers 10 can be set to have different numbers of the output.

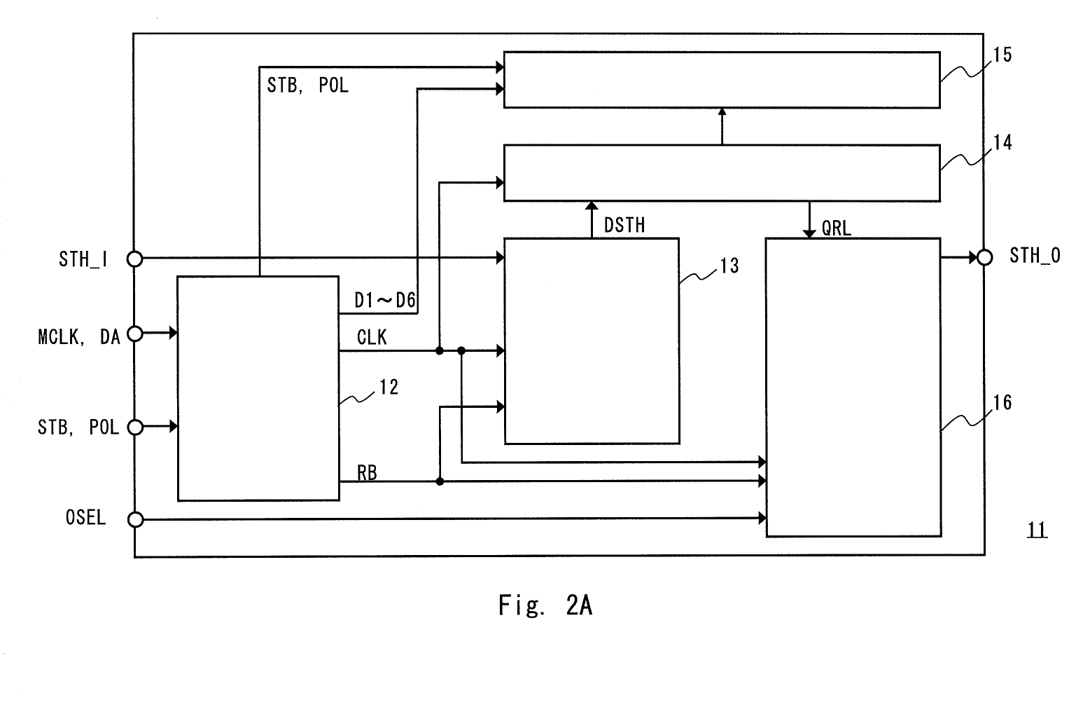

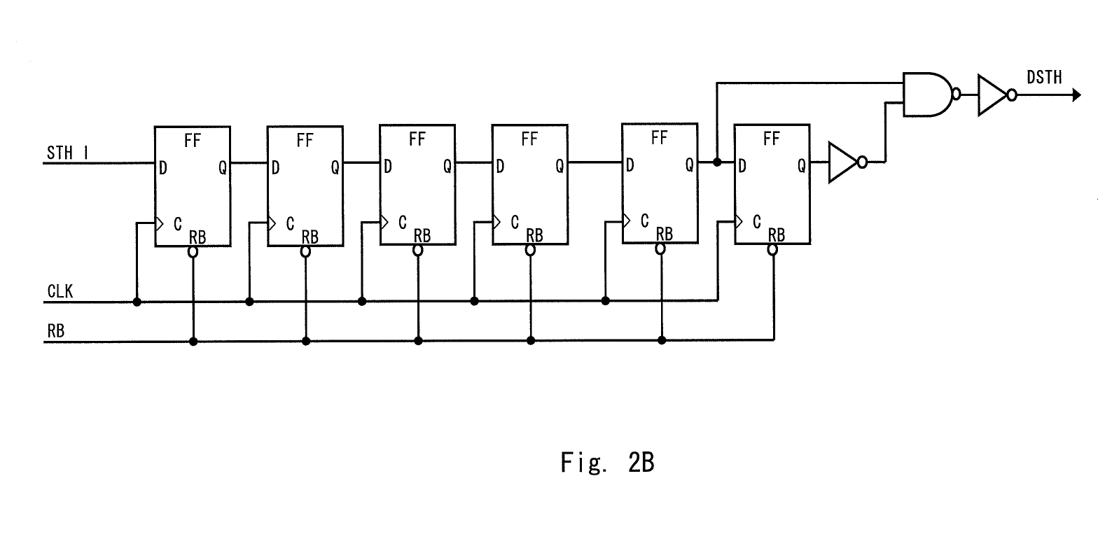

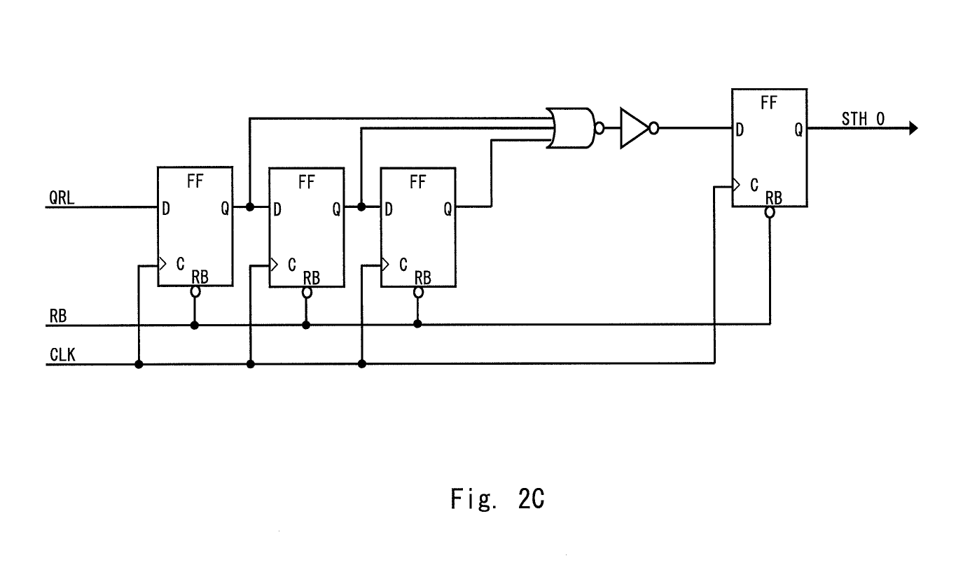

Each source driver 10 has an interface circuit 11 to transfer the start signal STH. FIG. 2A is a diagram showing a configuration of the interface circuit 11 as a comparative example of the source driver of the exemplary embodiment. As shown in FIG. 2A, the interface circuit 11 has a data controlling unit 12, a start signal capturing unit 13, a shift register unit 14, a data latch unit 15 and a start signal output unit 16.

While not be illustrated, the source driver 10 also has a DA converter, an output buffer and the like. The data latch unit 15 is coupled to the DA converter, and the DA converter is coupled to the output buffer. The DA converter converts digital RGB data latched by the data latch unit 15 to analog gray controlling voltage. The gray controlling voltage is output from the output buffer according to the strobe signal STB, and is applied to respective source lines of the liquid crystal display panel. In the explanation below, the start signal STH input to the source driver 10 is defined as “STH_I”, and the start signal STH output to the latter source driver 10 is defined as “STH_O”. It is apparent, from FIG. 1, that this output start signal STH_O is an input start signal STH_I of the latter source driver 10.

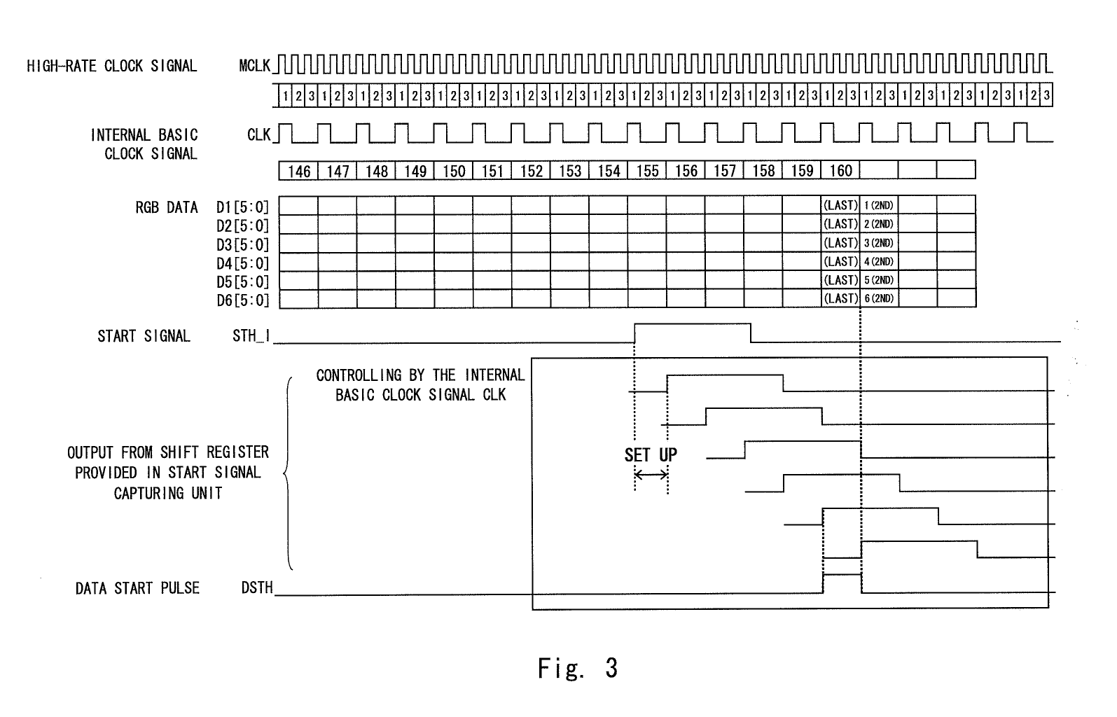

Here, referring to FIG. 2A, FIG. 2B and FIG. 3, is given an explanation of an operation of a comparative example. FIG. 2B is a diagram showing a configuration of a start signal capturing unit of the interface circuit shown in FIG. 2A. FIG. 3 is a timing chart to explain an operation of the interface circuit shown in FIG. 2A. As shown in FIG. 3, here is given an example where data processing is executed by six pixel data unit. In addition, in this example, the number of the outputs of the source driver 10 is 960 ch.

A data signal DA and a high rate clock signal MCLK are input to the data controlling unit 12 via high rate I/F. The data controlling unit 12 converts serial data signal DA to a plurality of pieces of parallel RGB data D1-D6. Furthermore, the data controlling unit 12 converts the clock signal MCLK to an internal basic clock CLK to transfer a plurality of pieces of RGB data. The internal basic clock signal CLK is supplied to the start signal capturing unit 13, the shift register unit 14 and the start signal output unit 16. Furthermore, the data controlling unit 12 outputs a reset signal RB to the start signal capturing unit 13 and the shift register unit 14. The reset signal RB is a signal which is produced according to the strobe signal STB and functions as a reset pulse to reset the start signal capturing unit 13 and the start signal output unit 16 prior to the start of data controlling.

The start signal STH_I and the internal basic clock CLK are input to the start signal capturing unit 13. Here, referring to FIG. 2B, is given an explanation of a configuration of the start signal capturing unit 13. As shown in FIG. 2B, the start signal capturing unit 13 has a shift register which is composed of six flip-flops connected in series, two inverters and a NAND circuit.

The start signal STH_I that is received is forwarded sequentially at the timing of the internal basic clock CLK by the shift register composed of flip-flops. The start signal capturing unit 13 produces data start pulse DSTH using the internal basic clock CLK shifted sequentially by the flip-flops. Specifically, an output signal from the fifth flip-flop and a signal obtained by inverting an output signal from the sixth flip-flop by the inverter are input to the NAND circuit. The output signal from the NAND circuit is inverted by the inverter and become data start pulse DSTH.

As shown in FIG. 3, using the time point of the rising edge of the start signal STH_I which corresponds to the last RGB data (Last) latched by the source driver 10, the data start pulse DSTH is produced at the timings of rising edges of the start signal STH_I of the initial RGB data (1(2nd)-6(2nd)) latched by the latter source driver 10. The data start pulses DSTH is supplied to the shift register unit 14.

Note that RGB data (Last) and data prior to the RGB data (Last) are RGB data which should be captured by the former source driver. Furthermore, RGB data (1(2nd)-6(2nd)) and the following data are data which should be captured by the latter source driver that produces the output of the shift register and the data start pulse DSTH.

The data start pulse DSTH is forwarded sequentially by the shift register unit 14 according to the internal basic clock CLK, and is supplied to the data latch unit 15. The data latch unit 15 latches the parallel RGB data D1 to D6 sequentially according to the pulse signal from the shift register unit 14. That is, the data start pulse DSTH indicates a timing of latching the RGB DATA D1 to D6.

The shift register unit 14 outputs a flag signal QRL to the start signal output unit 16 before the data latch unit 15 finishes latching the effective data. FIG. 2C shows a configuration of the start signal output unit 16 of the interface circuit 11 shown in FIG. 2A. The start signal output unit 16 shifts the flag signal QRL sequentially according to the internal basic clock signal CLK using flip-flops shown in FIG. 2C. The start signal output unit 16 produces the start signal STH_O which becomes the start signal of the latter source driver 10 that is cascade-connected to the former source driver 10.

In this comparative example, with increasing the rate of the high rate clock signal MCLK in the source driver 10 due to liquid crystal display devices having super high resolution, the internal basic clock signal CLK should have higher rate, the internal basic clock signal CLK being used to forward the start signal STH between source drivers 10 connected in series. As shown FIG. 3, because the start signal STH is shifted according to the rising edge of the internal basic clock signal CLK, the time margin for setup and hold will be made small.

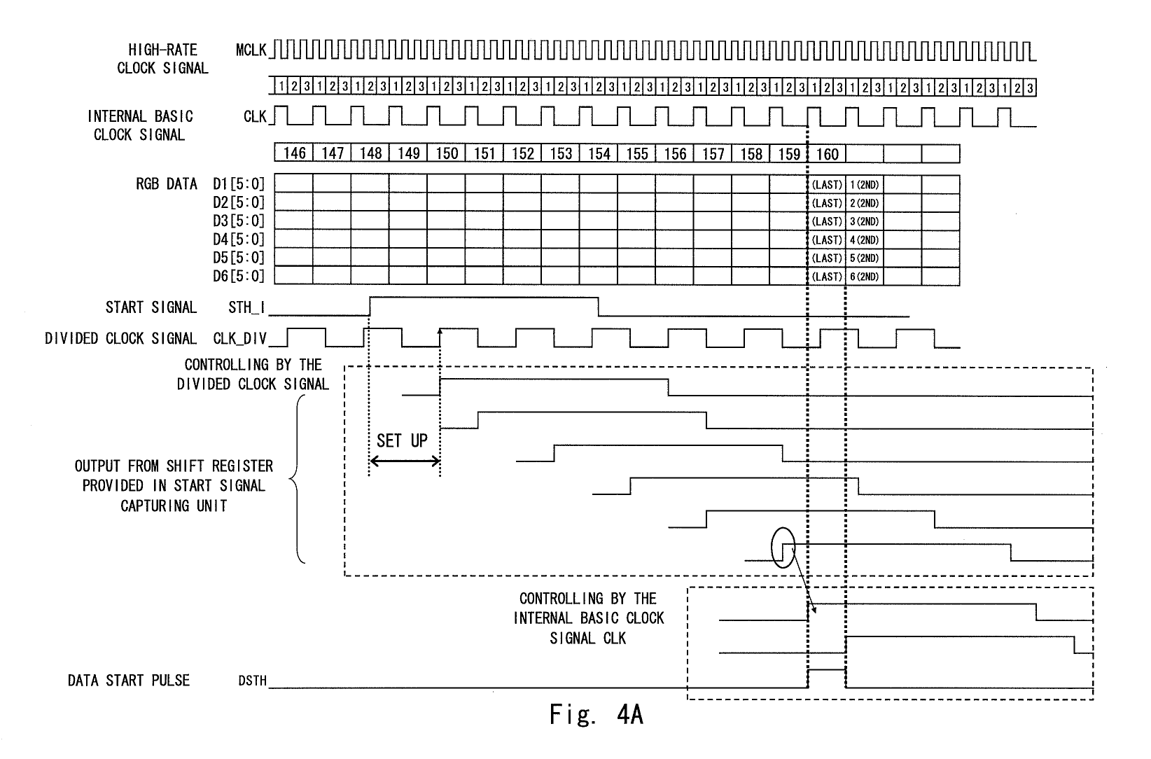

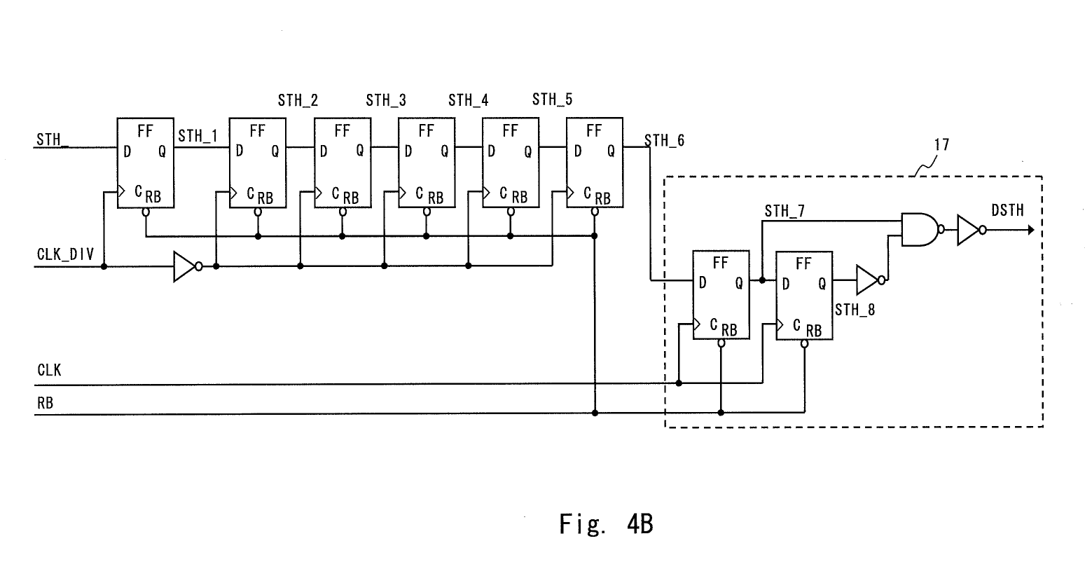

So, in order to secure time margin for setup and hold, the inventors have examined to use a divided clock signal indicating timing for the latter circuit to capture the start signal. Referring to FIG. 4A and FIG. 4B, here is given an explanation of an example for controlling the source driver 10 using a divided clock CLK_DIV. FIG. 4A is a timing chart to explain an operation of the comparative example in the case where the divided clock signal is used. FIG. 4B is a diagram showing a configuration of the start signal capturing unit 13 of the interface circuit 11 when the operation shown in FIG. 4A is executed. Similarly to FIG. 3, here is given an example where data processing is executed by six pixel data unit and the number of the outputs of the source driver 10 is 960 ch.

As shown in FIG. 4A, a divided clock signal CLK_DIV whose cycle is twice as long as the internal basic clock signal CLK is produced by the dividing operation. The start signal STH_I is captured by a shift-register at a rising timing of the divided clock signal CLK_DIV, the shift-register being arranged shown in FIG. 4B and being in the start signal capturing unit 13. As a result, time margin for setup and the like is secured. The start signal STH _I is then shifted sequentially at a timing of rising edge of the divided clock signal CLK_DIV.

The RGB data D1 to D6 are input according to the internal basic clock signal CLK. Accordingly, the data start pulse DSTH should be synchronized to the internal basic clock signal CLK. Because of this, the flip-flop in the data start pulse producing unit 17 shown in FIG. 4B shifts the start signal SHI_6 input from the shift register in synchronization with the internal basic clock signal CLK. As a result, as shown in FIG. 4A, the data start pulse DSTH is produced using the internal basic clock CLK.

While the start signal STH_I was shifted at the falling edge of the divided clock signal CLK_DIV in the previous example, the start signal STH_I is shifted at the rising edge of the internal basic clock signal CLK as shown in FIG. 4A. The data start pulse DSTH is produced according to the rising edge of the start signal STH_I which is shifted according to the internal basic clock signal CLK. However, the example shown in FIG. 4A has the following problem.

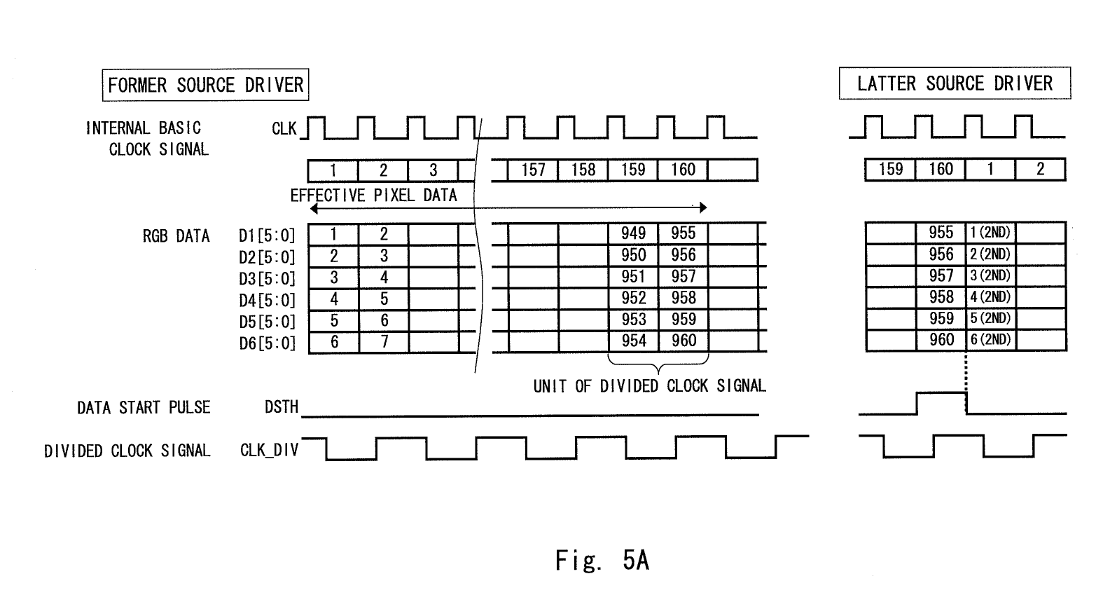

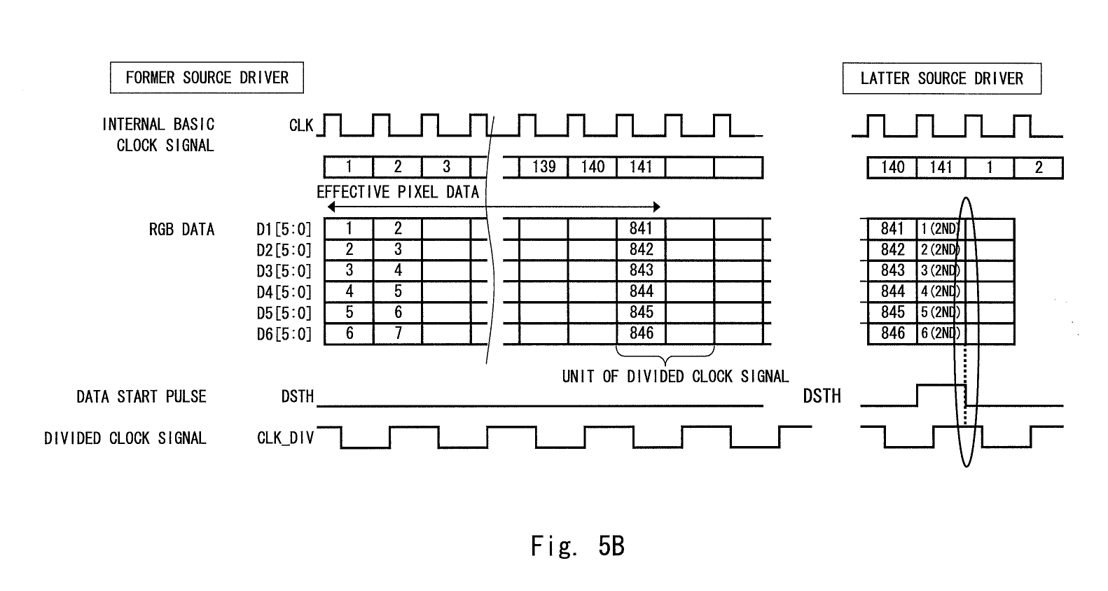

Referring to FIG. 5A and FIG. 5B, here is given an explanation of the problems of the example shown in FIG. 4A. In this example, 12-pixel data are processed in one cycle of the divided clock signal CLK_DIV. That is, 12-pixel data corresponds to one unit of the divided clock. FIG. 5A shows an example where the RGB data D1 to D6 end in the unit of the divided clock, that is, the RGB data has 960 ch, whereas FIG. 5B shows an example where the RGB data D1 to D6 do not end in the unit of the divided clock, that is, the RGB data has 846 ch.

In the example shown in FIG. 5A, the number of outputs of 960 ch can be divided by 12 which is one unit of the divided clock. Because of this, final data ends at the rising timing of the divided clock CLK_DIV. Change is made such that the start signal STH_I is shifted at the timing of the rising edge of the internal basic clock signal CLK, whereas the start signal STH_I was shifted at the timing of the falling edge of the divided clock CLK_DIV. By producing the data start pulse DSTH in this condition, the data start pulse DSTH is produced at the timing of outputting the final data. Accordingly, in this case, because the timing of the data start pulse DSTH matches the timing of the initial effective data of the latter source driver 10, the relationship between the effective data and output data does not collapse.

However, in the example shown in FIG. 5B, the number of outputs of 846 ch cannot be divided by 12 which is the unit of the divided clock. Because of this, the final data ends at the falling timing of the divided clock CLK_DIV. Change is made such that the start signal STH_I is shifted at the rising edge of the internal basic clock signal CLK, whereas the start signal STH_I was shifted at the falling edge of the divided clock CLK_DIV. By producing the data start pulse DSTH in this condition, the data start pulse DSTH is produced at the timing of outputting the initial data of the latter source driver 10. As a result, because the timing of the data start pulse DSTH does not match the timing of the initial effective data of the latter source driver 10, the relationship between the effective data and outputs collapses.

The inventers have thus come up with the following invention. Hereinafter, embodiments of the present invention will be shown and described with reference to reference numerals and symbols assigned to components in the figures. It should be noted that the present invention is not limited to following exemplary embodiments. In the following explanation, the same reference symbols indicate substantially the same components mentioned above in the comparative example.

As shown in FIG. 1, a source driver of this exemplary embodiment includes a plurality of source drivers 10 connected in series and is used for driving a liquid crystal display device. Signals input to the source driver 10 are the same as the example shown in FIG. 1, so detailed explanation thereof will be omitted. Each source driver 10 has an interface circuit 11 to transfer a start signal STH between plural source drivers 10 connected in series.

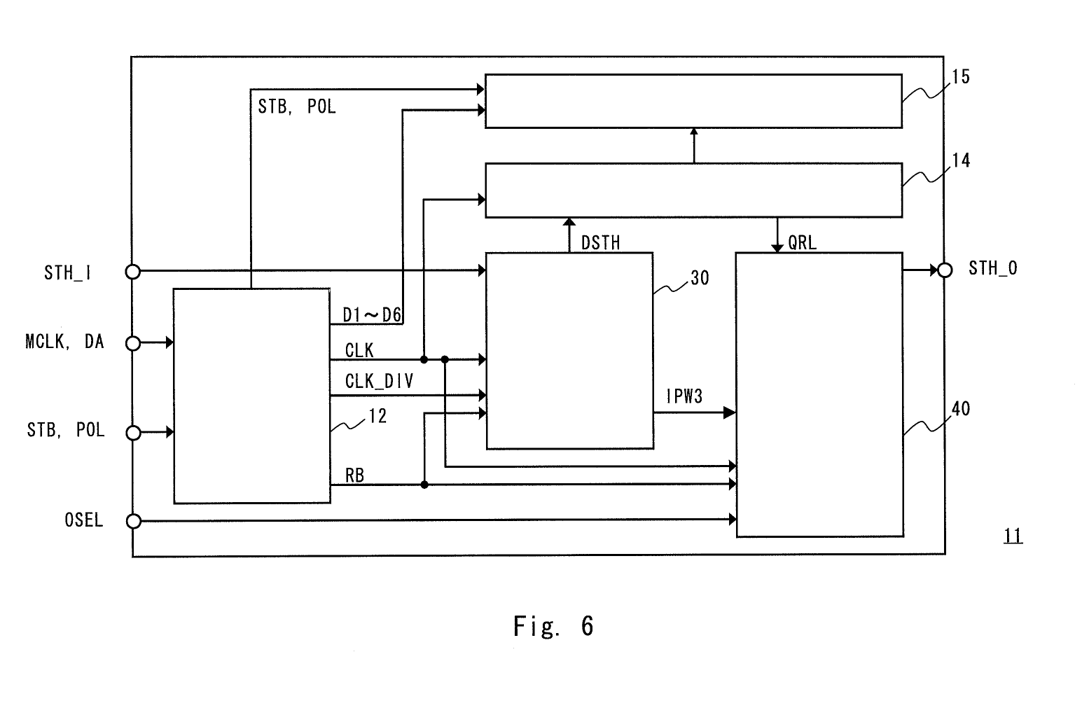

FIG. 6 is a diagram showing a configuration of the interface circuit 11 of the source driver 10 in the exemplary embodiment. As shown in FIG. 6, the interface circuit 11 has a data controlling unit 12, a shift register unit 14, a data latch unit 15, a start signal capturing unit 30 and a start signal output unit 40.

As mentioned above, the data controlling unit 12 converts serial data signal DA to plural parallel RGB data Dl to D6. Furthermore, the data controlling unit 12 converts the clock signal MCLK to the internal basic clock CLK to transfer plural RGB data. The internal basic clock signal CLK is supplied to each of the start signal capturing unit 30, the shift register unit 14 and the start signal output unit 40.

The data controlling unit 12 of this exemplary embodiment produces, as explained in FIG. 4A, the divided clock signal CLK_DIV which has a longer cycle than that of the internal basic clock signal CLK by dividing operation. Here, the divided clock signal CLK_DIV is produced having a cycle twice as long as that of the internal basic clock signal CLK by dividing operation. The divided clock signal CLK_DIV is supplied to the start signal capturing unit 30.

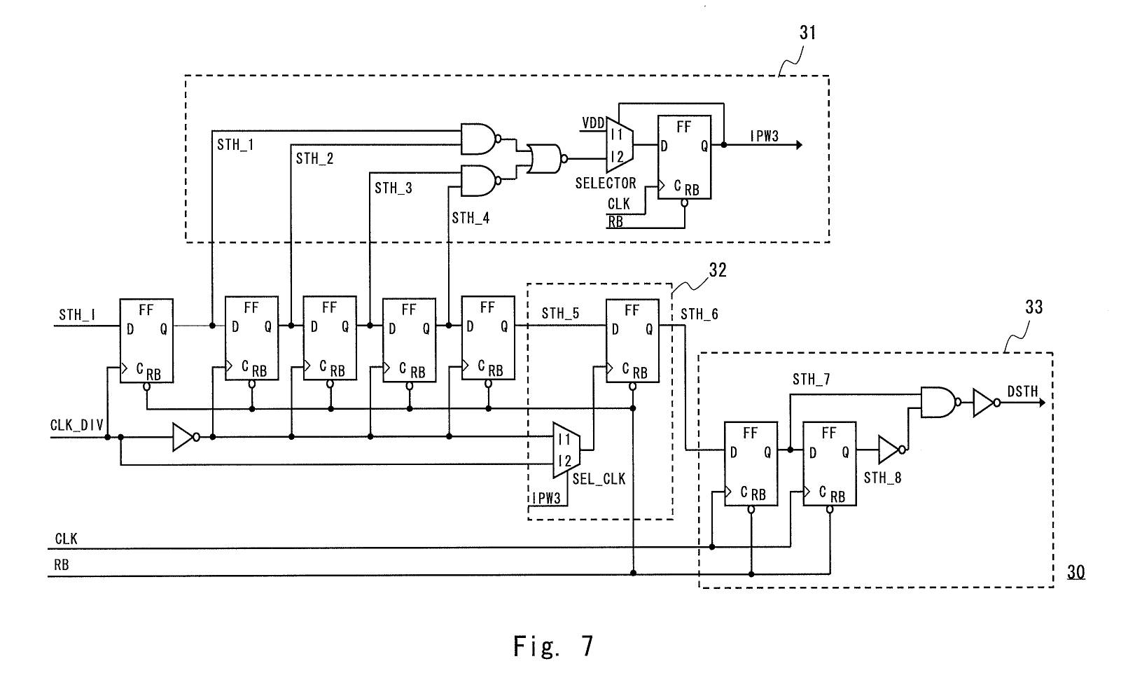

Here, referring to FIG. 7, is given an explanation for a configuration of the start signal capturing unit 30 of this exemplary embodiment. FIG. 7 is a diagram showing a configuration of the start signal capturing unit 30 of the source driver in the exemplary embodiment. As shown in FIG. 7, the start signal capturing unit 30 has flip-flops, a cascade pulse width determining unit 31, a data starting point adjusting unit 32 and a data start pulse producing unit 33.

The flip-flops shift the start signal STH_I according to the divided clock CLK_DIV. The cascade pulse width determining unit 31, using signals STH_I to STH_4 shifted by the flip-flops, determines the width of the start signal STH_I, and outputs an identifying signal IPW3. The cascade pulse width determining unit 31 has two NAND circuits, a NOR circuit, a selector and a flip-flop. The signals STH_1 and STH_2 are input to one NAND circuit, and the signal STH_3 and STH_4 are input to the other NAND circuit. Output signals from the two NAND circuits are input to the NOR circuit. These two two-inputs NAND circuits and one two-input NOR circuit constitute four-inputs AND circuit.

The data starting point adjusting unit 32 adjusts the starting point of the data start pulse DSTH according to the identifying signal IPW3. The data start pulse producing unit 33 produces the data start pulse DSTH which shows the timing to start latch of RGB data D1 to D6, using the start signal STH_6 adjusted by the data starting point adjusting unit 32.

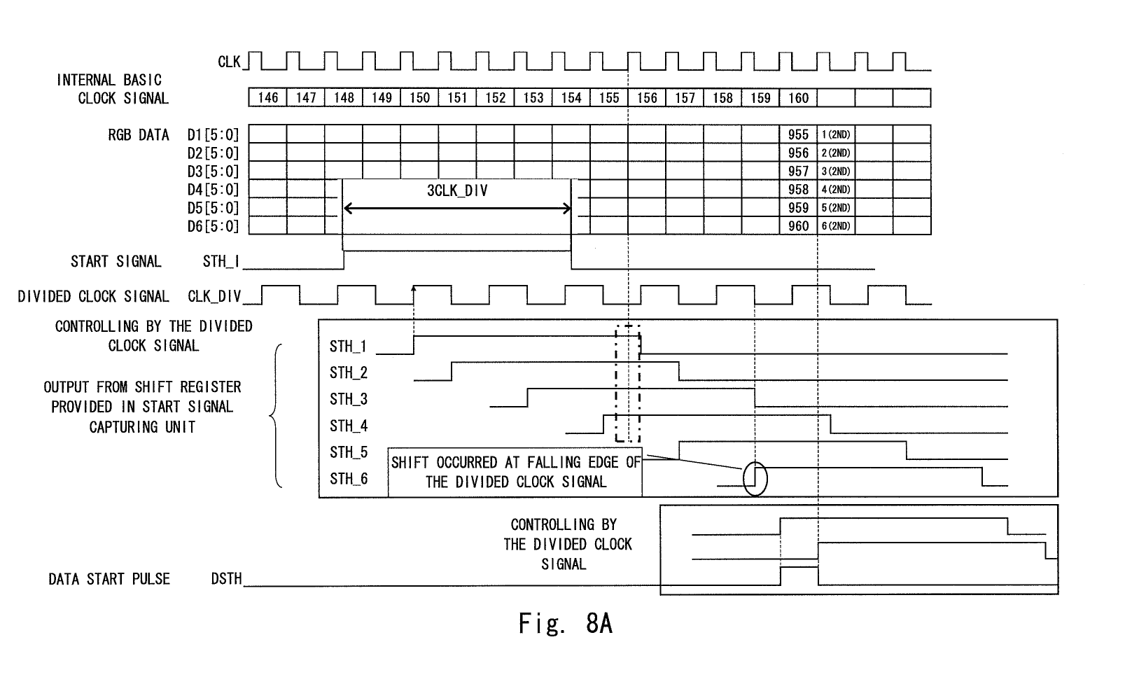

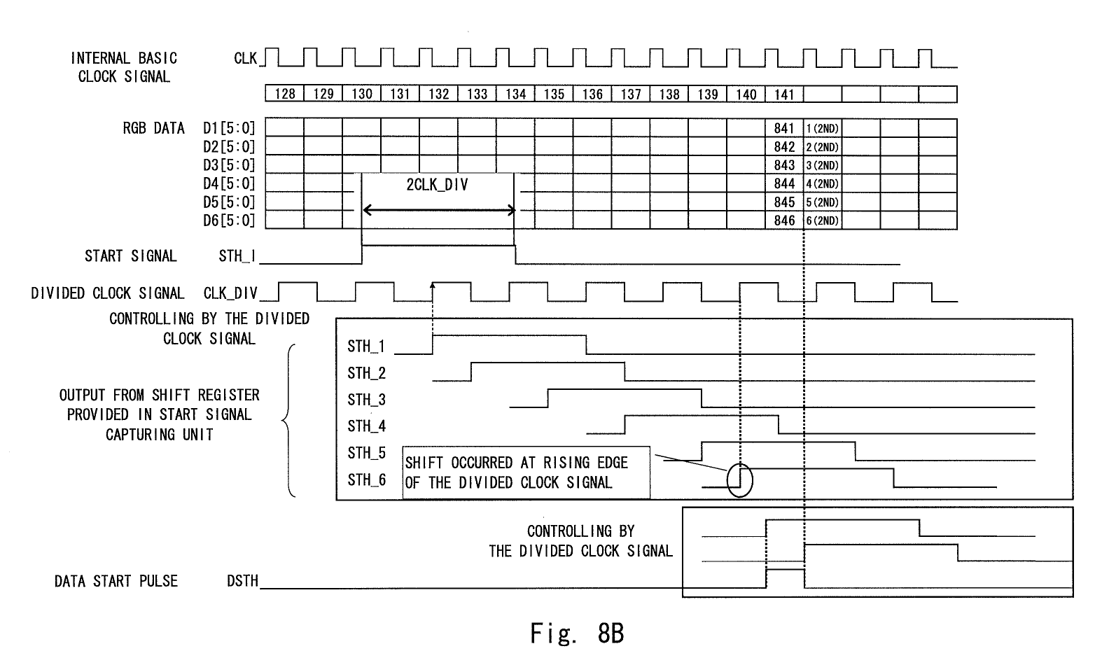

Here, referring to FIGS. 8A and 8B, is given an explanation for an operation for capturing the start signal STH_I. FIGS. 8A and 8B are timing charts to explain an operation for capturing the start signal STH_I by the interface circuit 11 of the source driver 10 in the exemplary embodiment. FIG. 8A shows the case where the number of the outputs is 960 ch and the pulse width of the start signal STH_I corresponds to three cycles of the divided clock CLK_DIV. FIG. 8B shows the case where the number of the outputs is 846 ch and the pulse width of the start signal STH_I corresponds to two cycles of the divided clock CLK_DIV.

Firstly, the flip-flop at the first stage captures the start signal STH_I and outputs the signal STH_1 according to the rising edge of the divided clock CLK_DIV. The signal STH_1 is shifted four times at the falling edge of the divided clock CLK_DIV. As a result, signals STH_2, STH_3, STH_4 and STH_5 are produced. Signals STH_1, STH_2, STH_3, STH_4 are supplied to the cascade pulse width determining unit 31. The signal STH_5 is supplied to the data starting point adjusting unit 32.

Next, the cascade pulse width determining unit 31 determines the pulse width of the start signal STH_I input to the flip-flop using signals STH_1 to STH_4, and outputs the identifying signal IPW3. The cascade pulse width determining unit 31 produces the identifying signal IPW3 in the following manner.

As shown in FIG. 8A, in the case where the start signal STH_I that is supplied has the width of three cycles of the divided clock CLK_DIV, there should be a timing when all signals STH_1 to STH_4 are set to the high level at the rising timing of the internal basic clock signal CLK. (see a chain line in FIG. 8A) At this timing, the identifying signal IPW3 becomes “High”. The selector switches to Il side coupled to VDD by this identifying signal IP3W. The identifying signal IPW3 remains High till the reset signal RB is input.

As shown in FIG. 8B, in the case where the start signal STH _I that is supplied has a width of two cycles of the divided clock CLK_DIV, there is no timing when all signals STH_1 to STH_4 become “High”. In this case, the identifying signal IPW3 is kept to be Low.

The data starting point adjusting unit 32 selects a normal signal or an inverted signal of the divided clock CLK_DIV which is selected based on the identifying signal IPW3. The signal which is selected by the data starting point adjusting unit 32 becomes a selected clock signal SEL_CLK. The data starting point adjusting unit 32 captures STH_5 into the flip-flop according to the rising edge of the selected clock signal SEL_CLK, and outputs STH_6 to the data start pulse producing unit 33.

As shown in FIG. 8A, in the case where the identifying signal IPW3 is High, the selected clock signal SEL_CLK is an inverted signal of the divided clock CLK_DIV. The STH_5 is obtained by the flip-flop of the data starting point adjusting unit 32 at the timing of falling edge of the divided clock CLK_DIV.

As shown in FIG. 8B, in the case where the identifying signal IPW3 is Low, the selected clock signal SEL_CLK is the divided clock CLK_DIV. The STH_5 is obtained by the flip-flop of the data starting point adjusting unit 32 at the timing of rising edge of the divided clock CLK_DIV. That is, shifting timings of the STH_6 vary according to the width of the start signal STH_I input.

The data start pulse producing unit 33 shifts STH_6 twice at the rising edge of the internal basic clock signal CLK to produce STH_7 and STH_8. The data start pulse producing unit 33 produces a data start pulse DSTH using the STH_7 and STH_8.

In this way, according to this exemplary embodiment, in the case where the width of the start signal STH that is received corresponds to two cycles of the divided clock CLK_DIV, the data start pulse DSTH is produced earlier by one clock timing of the internal basic clock signal CLK, because the final data does not end in the unit of the divided clock. As a result, the latter source driver 10 is able to synchronize the initial timing of the effective data with the output timing of the effective data.

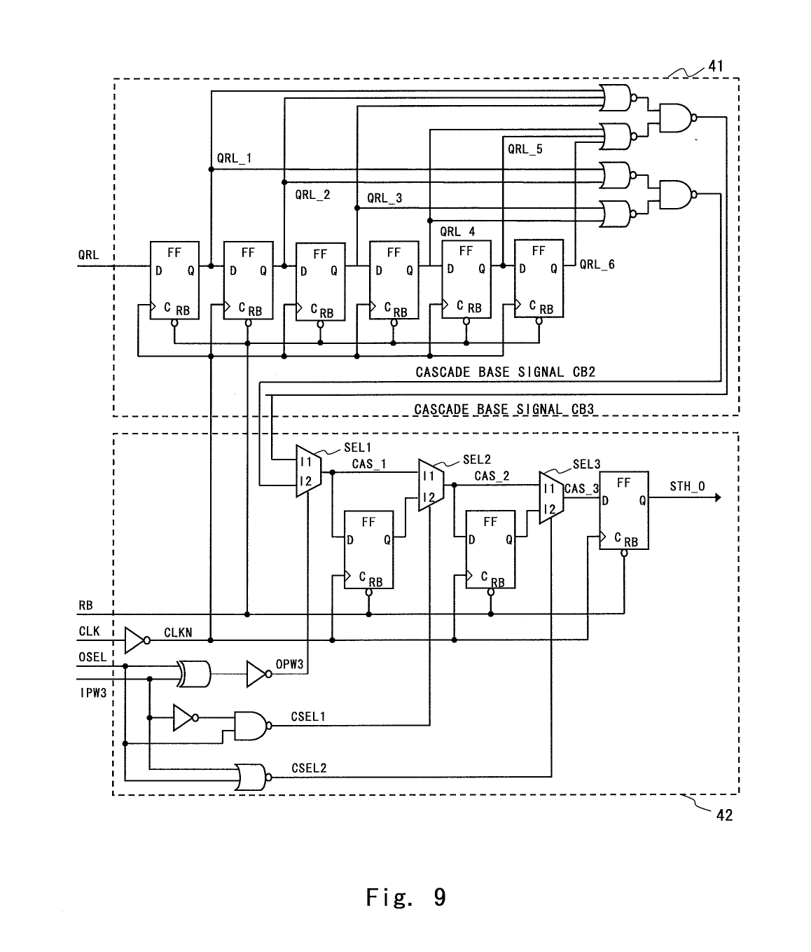

Here, referring to FIG. 9, is given an explanation for a configuration of the start signal output unit 40 of this exemplary embodiment. FIG. 9 is a diagram showing a configuration of the start signal output unit 40 of the source driver in the exemplary embodiment. As shown in FIG. 9, the start signal output unit 40 has a pulse producing unit 41 and an output timing adjusting unit 42.

The pulse producing unit 41 has flip-flops with six stages, four NOR circuits and two NAND circuits. The flag signal QRL is input to the pulse producing unit 41 from the shift register unit 14. The pulse producing unit 41 outputs a cascade base signal CB3 which has the pulse width of three cycles of the divided clock CLK_DIV, and a cascade base signal CB2 which has the pulse width of two cycles of the divided clock CLK_DIV.

The output timing adjusting unit 42 selects the cascade base signal CB3 or the cascade base signal CB2 based on an output pulse width selection signal OPW3, which will be described blow. The output timing adjusting unit 42 has an XOR circuit, a NAND circuit, a NOR circuit, three selectors and three flip-flops. The reset signal RB and internal basic clock signal CLK inverted by the inverter are supplied to the flip-flops of the pulse producing unit 41 and the output timing adjusting unit 42.

The setting signal OSEL and the identifying signal IPW3 are input to the XOR circuit. Output from the XOR circuit is inverted by the inverter and becomes the output pulse width selection signal OPW3. The output pulse width selection signal OPW3 is supplied to a selector SELL. The selector SELL selects the cascade base signal CB2 or the cascade base signal CB3 based on the output pulse width selection signal OPW3, and outputs CAS_1 to the selector SEL2 and the flip-flop.

The setting signal OSEL and identifying signal IPW3 inverted by the inverter are input to the NAND circuit. The NAND circuit outputs a selection signal CSEL1 to a selector SEL2. The selector SEL2 selects the CAS_1 or a signal from the flip-flop that receives the CAS_1, and outputs a signal as CAS_2. The setting signal OSEL and the identifying signal IPW3 are input to the NOR circuit.

The NOR circuit outputs the selection signal CSEL2 to a selector SEL3. The selector SEL3 selects the CAS_2 or a signal from the flip-flop that receives the CAS_2, and outputs CAS_3 to the last flip-flop. This flip-flop outputs STH_O which is a start signal for the latter source driver 10.

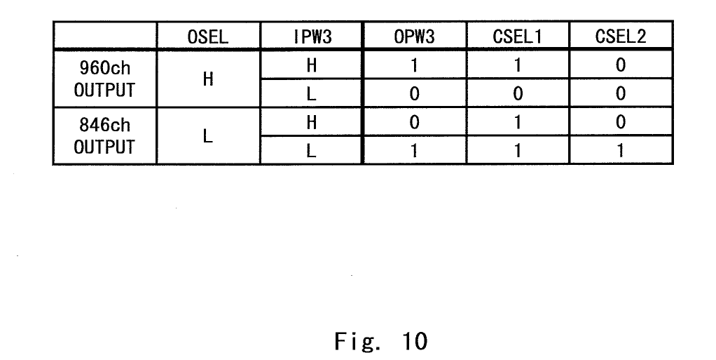

FIG. 10 shows states of each signal in the start signal output unit 40. As shown in FIG. 10, when the number of the outputs is 960 ch, the setting signal OSEL is “High”. When the number of the outputs is 846 ch, the setting signal OSEL is “Low”. When the number of the outputs is 960 ch and the identifying signal IPW3 is “High”, the output pulse width selection signal OPW3 is “1”, the selection signal CSEL1 is “1”, the selection signal CSEL2 is “0”. Furthermore, when the identifying signal IPW3 is “Low”, the output pulse width selection signal OPW3 is “0”, and the selection signal CSEL1 is “0”, the selection signal CSEL2 is

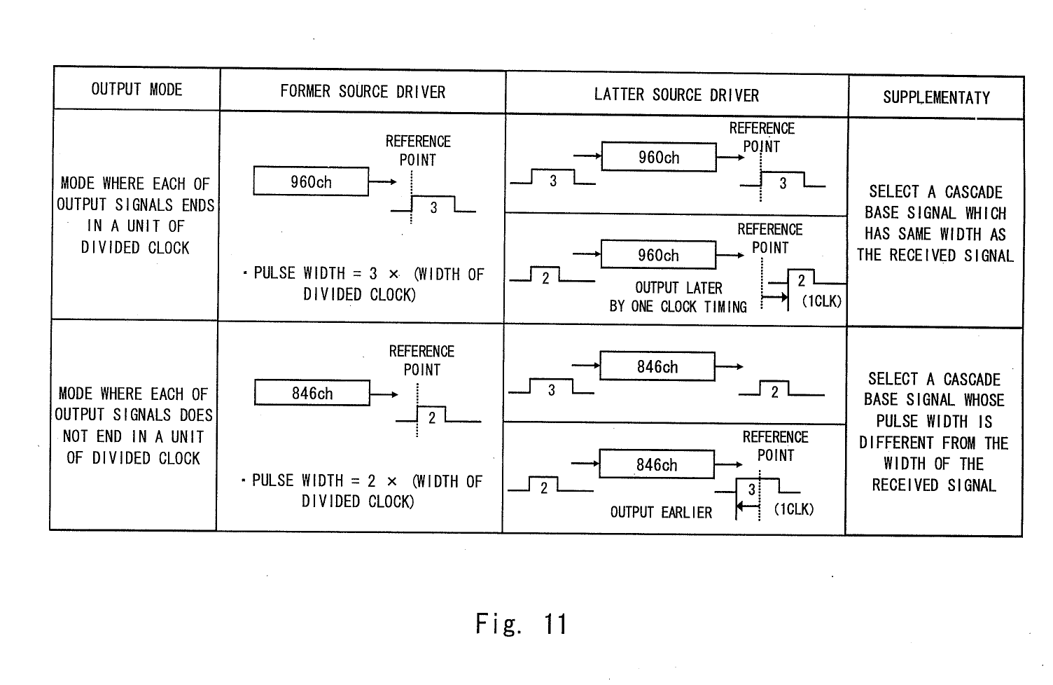

When the number of the outputs is 846 ch and the identifying signal IPW3 is “High”, the output pulse width selection signal OPW3 is “0”, the selection signal CSEL1 is “1”, and the selection signal CSEL2 is “0”. Furthermore, when the identifying signal IPW3 is “Low”, the output pulse width selection signal OPW3 is “1”, the selection signal CSEL1 is “1”, and the selection signal CSEL2 is “1”. Here, referring to FIG. 11, is given an explanation for an operation for outputting STH_O which becomes a start signal for the latter source driver 10. FIG. 11 is a diagram to explain output modes of the start signal output unit 40. Here, 960 ch is exemplified as a mode which can end in the unit of the divided clock CLK_DIV, and 846 ch is exemplified as a mode which cannot end in the unit of the divided clock CLK_DIV.

The pulse producing unit 41 captures a flag signal QRL from the shift register unit 14 into the flip-flop at the falling edge of the internal basic clock signal CLK, and outputs QRL_1. The signal captured into the flip-flop is shifted five times in the latter flip-flop at the falling edge of the internal basic clock signal CLK. As a result, QRL_2, QRL_3, QRL_4, QRL_5, and QRL_6 are produced.

Using QRL_1 to QRL_6, produced is the cascade base signal CB3 which has the pulse width of three cycles of the divided clock CLK_DIV. Furthermore, using QRL_1 to QRL_4, produced is the cascade base signal CB2 which has the pulse width of two cycles of the divided clock CLK_DIV. The cascade base signal CB2 and cascade base signal CB3 are supplied to the output timing adjusting unit 42.

The output timing adjusting unit 42 selects a pulse width of three cycles of the divided clock CLK_DIV or a pulse width of two cycles of the divided clock CLK_DIV, based on the output pulse width selection signal OPW3 mentioned above. As shown in FIG. 11, assuming the mode in which the number of the outputs ends in the unit of the divided clock (960 ch), the latter source driver 10 selects a cascade base signal which has the same pulse width as that of the start signal STH_I received from the former source driver 10.

For example, when input is the start signal STH_I which has the pulse width of three cycles of the divided clock CLK_DIV from the former source driver 10 whose number of the outputs is 960 ch, the latter source driver 10 whose number of the outputs is 960 ch selects the cascade base signal CB3 which has the pulse width of three cycle of the divided clock CLK_DIV.

Assuming the mode in which the number of the outputs does not end in the unit of the divided clock (846 ch), the latter source driver 10 selects the cascade base signal which has a pulse width different from that of the start signal STH_I received from the former source driver 10.

For example, when input is the start signal STH_I which has a pulse width of three cycles of the divided clock CLK_DIV from the former source driver 10 whose number of the outputs is 960 ch, the latter source driver 10 whose number of the outputs is 846 ch selects the cascade base signal CB2 which has the pulse width of two cycles of the divided clock CLK_DIV.

Then it is selected whether the selected cascade base signal CB2 or CB3 should be shifted once or twice or should not be shifted, using selection signals CSEL1 and CSEL2.

In the case where the mode is 960 ch in which the number of the outputs ends in the unit of the divided clock, when the received start signal STH_I has the pulse width of three clocks of the divided clock CLK_DIV, the selection signal CSEL1 is “1” and the selection signal CSEL2 is “0”. In this condition, the cascade base signal CB3 is shifted once by the flip-flop. The rising edge of CAS_3 when shifted once is made to be standard.

Furthermore, in the case where the mode is 960 ch in which the number of the outputs ends in the unit of the divided clock, when the received start signal STH_I has the pulse width of two clocks of the divided clock CLK_DIV, the selection signal CSEL1 is “0” and the selection signal CSEL2 is “0”. In this condition, the cascade base signal CB2 is shifted twice by the flip-flop. Since the cascade base signal CB2 is shifted twice, the rising edge of the CAS_3 becomes later than the standard by one cycle of the internal basic clock signal CLK.

In the case where the mode is 846 ch in which the number of the outputs cannot end in the unit of the divided clock, when the received start signal STH_I has the pulse width of three clocks of the divided clock CLK_DIV, the selection signal CSEL1 is “1” and the selection signal CSEL2 is “0”. In this condition, the cascade base signal CB3 is shifted once by the flip-flop. Since the cascade base signal CB3 is shifted once, the rising edge of the CAS_3 is the same as the standard.

Furthermore, in the case where the mode is 846 ch in which the number of the outputs cannot end in the unit of the divided clock, when the received start signal STH_I has the pulse width of two clocks of the divided clock CLK_DIV, the selection signal CSEL1 is “1” and the selection signal CSEL2 is “1”. In this condition, the cascade base signal CB2 is not shifted by the flip-flop. Since the cascade base signal CB2 is not shifted, the rising edge of the CAS_3 is earlier than the standard by one cycle timing of the internal basic clock signal CLK. The selected signal CAS_3 described above is captured by the last flip-flop at the falling edge timing of the internal basic clock signal CLK, and SHT_O as the start signal for the latter source driver 10 is output.

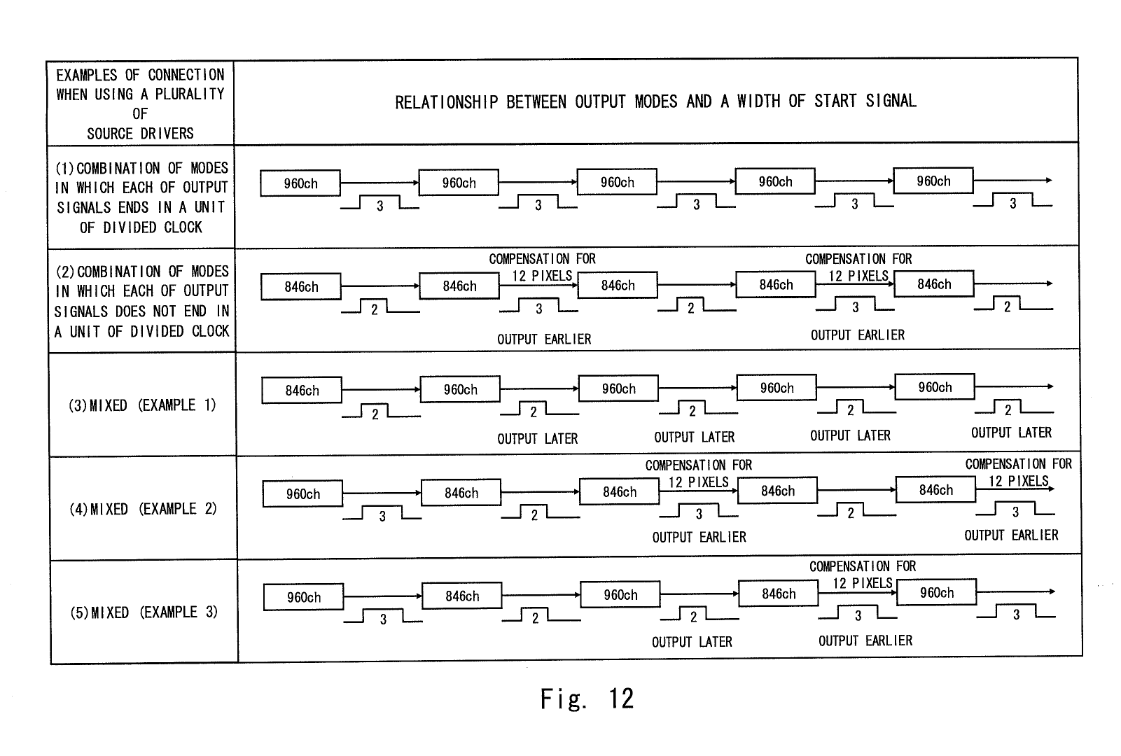

FIG. 12 shows an example of control processing when plural source drivers are connected in series. As shown in FIG. 12(1), in a combining mode in which the number of the outputs ends in the unit of the divided clock—(e.g., five source drivers 10 having 960 ch are connected in series), the effective data of each source driver 10 ends in the unit of divided clock. Because of this, the start signal STH sequentially transferred between source drivers 10 has the pulse width of three cycles of the divided clock CLK_DIV, and is output according to the timing of the standard.

As shown in FIG. 12(2), in a combining mode in which the number of the outputs does not end in the unit of the divided clock—(e.g., five source drivers 10 having 846 ch are connected in series), the effective data of each source driver 10 does not end in the unit of the divided clock. The start signal STH whose pulse width is two cycles of the divided clock CLK_DIV indicates deficiency of six-pixel data because the effective data of the former source driver 10 does not end in the unit of the divided clock. That is, the start signal STH whose pulse width is two cycles of the divided clock CLK_DIV becomes an identifying signal to deliver the information that six-pixel data are lacked.

When the latter source driver 10 receives the start signal STH whose pulse width is two cycles of the divided clock CLK_DIV, the latter source driver 10 is able to adjust the timing to the initial timing of the effective data, by producing the data start pulse DSTH earlier by one clock timing of the internal basic clock signal CLK.

Furthermore, an outputting timing for STH_O which is the start signal STH for the latter source driver 10 should be always output at the rising edge timing of the divided clock CLK_DIV. When receiving the start signal STH whose pulse width is two cycles of the divided clock CLK_DIV, by adjusting the output timing of STH_O which is output to the latter source driver 10, the source driver 10 is always able to output STH_O at the rising edge of the divided clock CLK_DIV.

In the example shown in FIG. 12(2), the second and forth source drivers 10 output the start signal STH earlier by one cycle timing of the internal basic clock signal CLK, whereby, adjustments for 12 pixels are made at each source driver. Furthermore, in this invention, even in the case where source drivers 10 having different number of the outputs are connected in series, RGB data are able to be obtained properly according to the starting timing of effective data for each of the source drivers 10.

In the example shown in FIG. 12(3), the number of the outputs of the first source driver 10 is 846 ch and the number of the outputs of four latter source drivers 10 is 960 ch. As described above, by adjusting the timing of the data start pulse DSTH, it is possible to synchronize the staring timing of the effective data with the timing of latching. Furthermore, the source drivers 10 of the second stage and the following source drivers 10 output the start signal STH whose pulse width is two cycles of the divided clock CLK_DIV later by one cycle of the internal basic clock signal CLK. As a result, the STH_O is able to be output at the rising timing of the divided clock CLK_DIV.

Furthermore, in the example shown in FIG. 12(4), the number of the outputs of the first source driver 10 is 960 ch, and the number of the outputs of four latter source drivers 10 is 846 ch. In this case, adjustments for 12-pixel data are made at each of the third and fifth source drivers 10.

By outputting the start signal STH earlier by one cycle of the internal basic clock signal CLK, it is possible to output the STH_O at the rising edge of the divided clock CLK_DIV.

As shown in FIG. 12(5), source drivers 10 with 960 ch and source drivers 10 with 846 ch are alternately connected in series. In this case, the third source driver 10 with 960 ch outputs the start signal STH for the latter source driver 10 later by one cycle of the internal basic clock signal CLK. Furthermore, the next source driver 10 with 846 ch outputs the start signal STH for the latter source driver 10 earlier by one cycle of the internal basic clock signal CLK. As a result, it is possible to synchronize the staring timing of the effective data with the timing of latching and also it is possible to output STH_O at the timing of the rising edge of the divided clock CLK_DIV.

As described above, according to this invention, in the case where the effective data output from the source driver 10 does not end in the unit of the divided clock, it is possible to change pulse width of the start signal which is output to the latter source driver 10. The latte source driver 10 determines the status of data ending in the former source driver 10 according to the pulse width of the received start signal and is able to capture the data according to the starting timing of the effective data.

It should be noted that the present invention is not limited to the above embodiments, but modifications, improvements, and the like within the range in which the object of the present invention can be attained are included in the present invention. The number of the outputs, the pulse width and the like described above are merely examples, and the present invention is not limited to the examples described above.

While the invention has been described in terms of several exemplary embodiments, those skilled in the art will recognize that the invention can be practiced with various modifications within the spirit and scope of the appended claims and the invention is not limited to the examples described above. The exemplary embodiments mentioned above can be combined as desirable by one of ordinary skill in the art. Further, the scope of the claims is not limited by the exemplary embodiments described above. Furthermore, it is noted that, Applicant's intent is to encompass equivalents of all claim elements, even if amended later during prosecution.

What is claimed is:

1. A driver circuit comprising plural source drivers connected in series, in a period from the time a start signal forwarded between plural source drivers is obtained by a former source driver to the time the start signal is obtained by a latter source driver, the former source driver obtaining data according to a timing of a basic clock and outputting the start signal to the latter source driver, each of the source drivers comprising:
a dividing circuit producing a divided clock by dividing the basic clock;
a start signal capturing unit capturing the start signal at an edge of the divided clock;
a pulse width determining unit determining the pulse width of the start signal that is captured; and
a data starting point adjusting unit changing the timing to start capturing the data according to the pulse width of the start pulse.

2. The driver circuit according to claim 1, further comprising a start signal output unit producing the start signal for the latter source driver, wherein the start signal output unit changes the timing and the pulse width of the start signal output to the latter source driver according to the pulse width of the start signal that is captured and the number of the outputs of this source driver.

3. The driver circuit according to claim 2, wherein the start signal output unit does not change the pulse width in the case where the number of the outputs of the source driver ends in the unit of the divided clock, and the start signal output unit changes the pulse width in the case where the number of the outputs of the source driver does not end in the unit of the divided clock.

4. The driver circuit according to claim 3, wherein in the case where the start signal that is captured indicates that effective data does not end in the unit of the divided clock,
the start signal output unit outputs the start signal to the latter source driver later than standard by one cycle of the basic clock when the number of the outputs of this source driver ends in the unit of the divided clock, and
the start signal output unit outputs the start signal to the latter source driver earlier than standard by one cycle of the basic clock when the number of the outputs of this source driver does not end in the unit of the divided clock.
